(19) United States
(12) Patent Application Publication
(10) Pub. No.: US 2008/0056455 A1
(43) Pub. Date: Mar. 6, 2008

(54) Apparatus and Method of Generating Composite Audio Signals

(75) Inventors: Hanqi Yang, Apex, NC (US); Shuang Guo, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/465,225

(22) Filed: Aug. 17, 2006

(51) Int. Cl. H04M 1/64

(52) U.S. Cl. 379/88.01

(57) ABSTRACT

A communication device such as a wireless communication device or an entity in a wireless communication network includes a mixer circuit and a speech codec. The mixer circuit generates a composite audio signal that includes speech signals received from a user of the device and supplemental audio signals generated from a selected audio file. The speech codec speech encodes the composite audio signal for transmission to a remote party via a communication network.

### BACKGROUND

The present invention relates generally to communication devices, and particularly to communication devices configured to mix audio signals for communication with remote parties.

Consumers often seek innovative features and new functionality when purchasing a wireless communication device. Of course, consumer interest in what was once new and innovative often wanes quickly. Thus, manufacturers and service providers sometimes struggle to keep abreast of consumer demand. Those that cannot get new features to market fast enough may find themselves losing market share.

One of the most popular and widely used features continues to be the ability to converse with a remote party. However, other popular features and functions currently available facilitate interaction between the user and their wireless communication device. Manufacturers could benefit if they offered new features and functions that allowed the user to interact with their wireless communication device to enhance their conversations.

### SUMMARY

The present invention provides an apparatus and method that allows users to enhance their voice conversations with supplemental audio. In one embodiment of the present invention, a user's communication device comprises a controller, a speech codec, and a mixer circuit. The mixer circuit generates a first composite audio signal responsive to a first control signal generated by the controller. The first composite audio signal comprises speech signals representing a user's voice mixed with supplemental audio signals derived from a selected audio file. The speech codec speech encodes the first composite audio signal for transmission to a remote party. Upon receipt, the remote party's device decodes the first composite audio signal such that the remote party hears the user's voice and the supplemental audio signals as a composite audible sound.

The mixer may also generate a second composite audio signal comprising speech signals representing the remote party's voice mixed with the supplemental audio signals. The speech codec on the user's device decodes the second composite audio signals such that the user hears the remote party's voice and the supplemental audio signals as a composite audible sound.

In another embodiment, the mixer circuit, the controller, and one or more speech codecs are disposed in a server at a communication network. Responsive to the controller, the speech codecs decode the incoming audio signals from the user and the remote party for output to the mixer circuit. The mixer circuit then generates first and second composite audio signals. The first composite audio signal includes the user's decoded speech signals mixed with the supplemental audio signals. The second composite audio signals include the remote party's speech signals mixed with the supplemental audio signals. The speech codecs then re-encode the first and second composite audio signals before transmitting the first and second composite audio signals to the remote party and the user, respectively. Upon receipt, speakers at their respective communication devices render their respectively-received composite audio signals as composite audible sound.

### BRIEF DESCRIPTION OF THE DRAWINGS

FIG. 1 illustrates an example of a communication system suitable for use with one embodiment of the present invention.

FIG. 2 is a functional block diagram that illustrates a wireless communication device configured to operate according to one embodiment of the present invention.

FIG. 3 is a functional block diagram of a circuit configured to operate according to one embodiment of the present invention disposed within a wireless communication device.

FIG. 4 is a flow diagram illustrating a method by which the circuit of FIG. 3 may operate according to one embodiment of the present invention.

FIG. 5 is a functional block diagram of a circuit configured to operate according to an alternate embodiment of the present invention disposed within a wireless communication network.

FIG. 6 is a flow diagram illustrating a method by which the circuit of FIG. 5 may operate according to an alternate embodiment of the present invention.

### DETAILED DESCRIPTION

The present invention allows a user of a communication device to inject selected background audio into a voice conversation between the user and one or more remote parties. The background audio may be, for example, music selected to create, foster, or portray a user's current emotional feeling such as romance or anger to a remote party. The background audio may also be sounds selected by the user to simulate a desired scenario. For example, a user wishing to terminate a conversation may selectively inject sounds into the conversation to provide a reason for the user to terminate the call. Examples of such sounds include, but are not limited to, the sounds of a crying baby, and bothersome sounds such as those of a train station, subway station, a busy highway, or “static”. The user may also use the background audio to greet a designated remote party before the user answers the call. Once the user answers the call, the user may selectively continue to allow the background audio to be injected into the conversation.

In one embodiment, the present invention is embodied as a mixing circuit disposed in the user's communication device such as a cell phone. In another embodiment, the present invention is embodied as a mixing circuit disposed at a server in a communication network that communicatively connects the user and one or more remote parties. Regardless of the embodiment, however, the mixing circuit mixes incoming and outgoing speech signals representing a voice conversation between a user and a remote party with the audio of a selected audio file. After mixing, the mixing circuit sends the mixed audio signals as a composite audio signal to the remote party and/or to a speaker at the user's device. The user and the remote party hear the mixed signals as a composite audible sound.

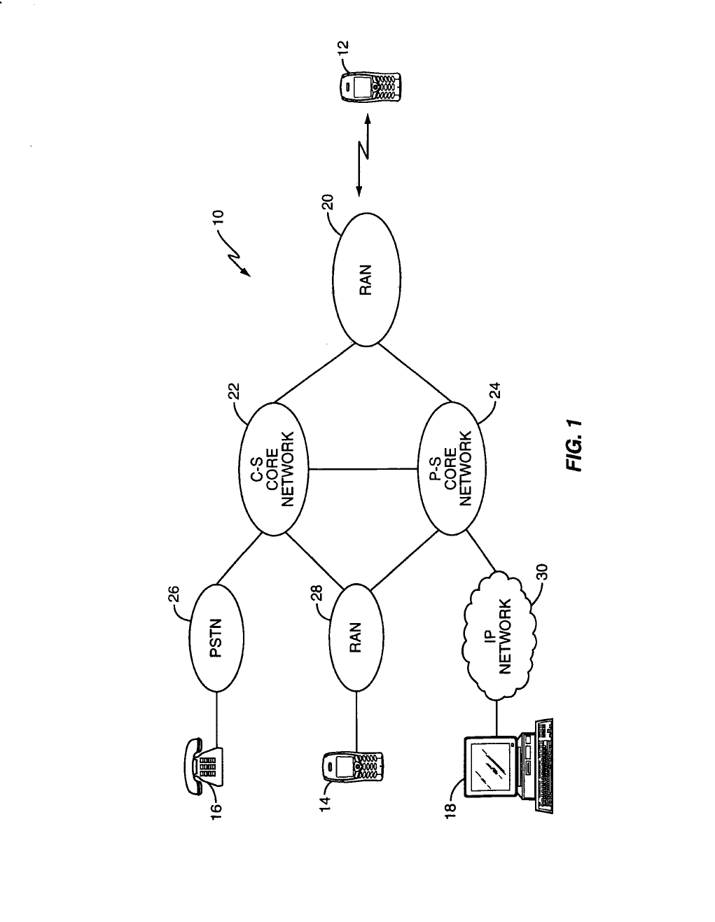

FIG. 1 illustrates an exemplary communications network indicated generally by the numeral 10. Network 10 is an example of a system that is suitable for communicatively connecting a user of a wireless communications device 12 and one or more remote parties 14, 16, 18. Each of the network components and their interactions are well documented and understood by those in the art. Therefore, only a brief description of their functionality and their interaction is included herein for context.

Network 10 includes a radio access network (RAN) 20, a circuit-switched core network (CS-CN) 22, and a packet-switched core network (PS-CN) 24. The RAN 20 supports circuit-switched and/or packet-switched radio communications with wireless communications device 12 over an air interface. The RAN 20 may comprise, for example, a UMTS RAN (UTRAN), cdma2000, GSM, or other radio access network.

The CS-CN 22 provides a connection to the Public Switched Telephone Network (PSTN) 26 and/or an Integrated Digital Services Network (ISDN) for circuit-switched services, such as voice services, fax services, or other data services. A remote party 16 using a landline device such as a household telephone, for example, may connect to the CS-CN 22 and the wireless communications device 12 via the PSTN 26. The CS-CN 22 may also connect to one or more additional RANs 28 to connect one or more additional remote parties 14 using other wireless devices. In some embodiments, the CS-CN 22 interconnects with the PS-CN 24 using methods well known in the art.

The PS-CN 24 provides the wireless communications device 12 access to an IP network 30 such as the Internet or other packet data network (PDN). Typically, the wireless communications device 12 accesses the PS-CN 24 via RAN 20 or other access point. However, the wireless communications device 12 may access the IP network 30 via an access point (not shown) operating according to the IEEE 802.11 standards. A remote party 18 using a computing device such as a personal computer or other wireless device, for example, may connect to the PS-CN 24 and the wireless communications device 12 via the IP network 30.

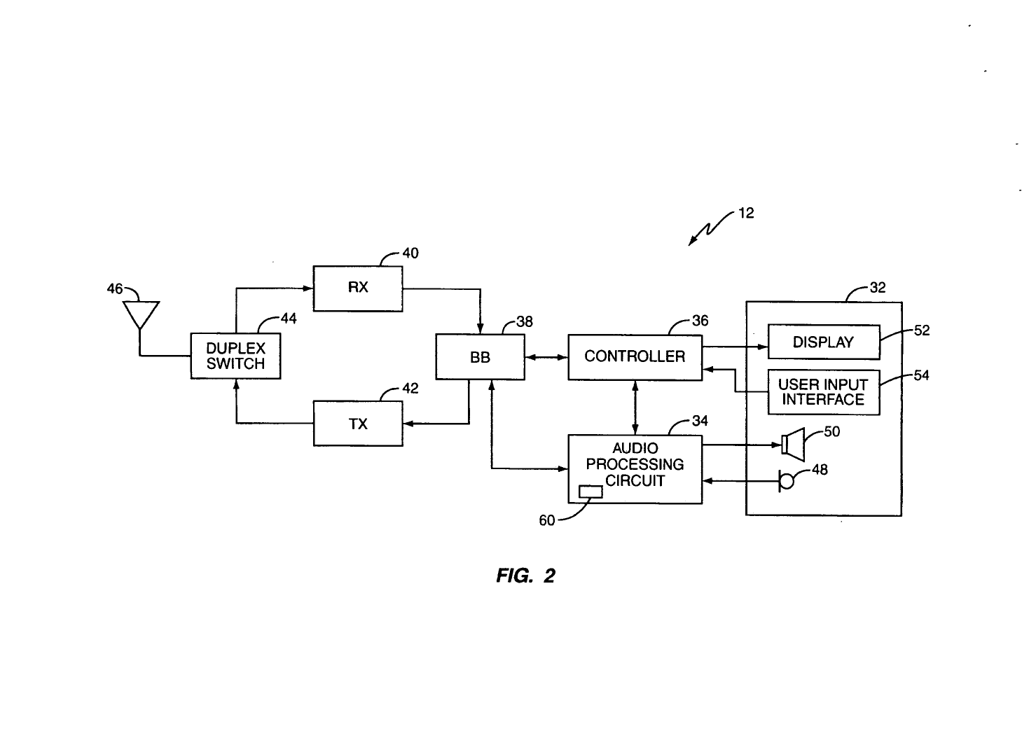

FIG. 2 illustrates one embodiment of a communications device 12 that is configured to generate a composite audio signal comprising the user's speech signals supplemented with audio signals derived from a selected audio file. As used herein, the term “communications device” connotes a broad array of device types. For example, the communications device 12 illustrated in the figures may comprise a cellular radiotelephone, a Portable Digital Assistant (PDA), a palmtop or laptop computer or a communication module included within a computer, a satellite phone, or other type of communication device. It also should be understood that the architectural details of the communications device 12 and the particular circuit elements incorporated therein may vary according to its intended use.

The illustrated communications device 12 of FIG. 2 comprises a device that is capable of communicating with one or more of the remote parties 14, 16, 18 over the CS-CN 22 and/or the PS-CN 24. The details of how these communication links are established are well known, and thus, not described in detail herein.

The communications device 12 comprises a user interface (UI) 32, an audio processing circuit 34, a system controller 36, baseband control circuit(s) 38, a receiver 40, a transmitter 42, a switch/duplexer 44, and a receive/transmit antenna 46. The UI 32 includes a microphone 48, a speaker 50, a display 52, and one or more user input devices 54. Microphone 48 converts the user's speech into electrical audio signals and speaker 50 converts audio signals into audible sound for the user.

The audio processing circuit 34 provides basic analog output signals to speaker 50 and accepts analog audio inputs from microphone 48. Additionally, as discussed in more detail later, the audio processing circuit 34 may include circuitry 60 that generates a composite audio signal for transmission to one or more remote parties 14, 16, 18. This permits a user to selectively inject music or other sounds into a voice conversation to simulate some desired scenario or portray an emotional state of mind. This also allows users to greet calling parties with predetermined sounds (e.g., music) before answering a call, or to inject sounds without terminating or suspending the call so that a remote party waiting for the user to return to a conversation does not become bored. Display 52 allows the user to view information, while the user input interface 54 receives user commands, selections, and other user input used to control the operation of communication device 12.

The antenna 46 allows the communications device 12 to receive incoming transmissions over established circuit-switched and packet-switched connections. The antenna 46 further allows the communications device 12 to transmit outbound signals over the circuit-switched and packet-switched connections. The switch/duplexer 44 connects the receiver 40 or the transmitter 42 to the antenna 46 accordingly. It should be understood that the receiver 40 and the transmitter 42 are illustrated herein as separate components; however, this is for illustrative purposes only. Some embodiments may integrate receiver 40 and transmitter 42 circuitry into a single component referred to herein as a transceiver.

Generally, a received signal passes from the receiver 40 to the baseband control circuit 38 for channelization, demodulation, and decoding. The baseband control circuit 38 may also perform speech encoding/decoding on the transmitted and received signals. The system controller 36, which controls the operation of the wireless communications device 12, may receive the decoded signal, or control the baseband control circuit 38 to send the decoded signal to the audio processing circuit 34 for further processing. The audio processing circuit 34 converts the decoded data in the signal from a digital signal to an analog signal for rendering as audible sound through the speaker 50.

In one embodiment, the baseband control circuit 38 decodes voice data received over the circuit-switched connection using an Adaptive Multi-Rate (AMR) scheme. AMR is a speech compression scheme used in some networks to encode voice data. AMR uses various techniques to optimize the quality and robustness of the voice data being transmitted over the network. AMR is defined in the 3GPP specification standard “3GPP TS 26.071 v6.0.0,” Release 6, which is incorporated herein by reference in its entirety.

Baseband control circuit 38 may also decode packetized voice data received over the packet-switched connection using a G.711 compression scheme. G.711 encodes samples of voice signals sampled at 8000 times/second to generate a 64 Kbit/sec bit stream. G.711 is described in the ITU specification standard entitled “Pulse Code Modulation (PCM) of Voice Frequencies,” which is incorporated herein by reference in its entirety.

For transmitted signals, the baseband control circuit 38 converts an analog signal such as the user's voice detected at microphone 48 into a digital signal, and encodes the digital signal into data using the appropriate protocol for the network (e.g., AMR, G.711). The baseband control circuit 38 then performs channelization encoding and modulation as is known in the art. The modulated signal is then sent to transmitter 42 for transmission over the appropriate circuit-switched or packet-switched connection, depending upon the intended remote party.

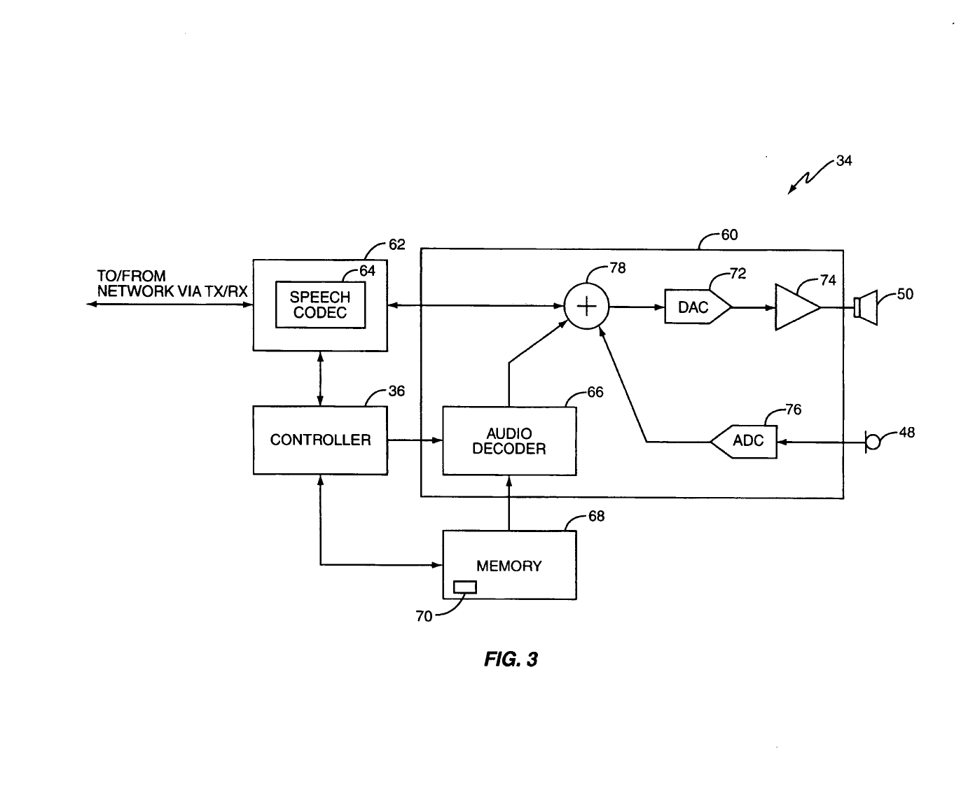

FIG. 3 illustrates the audio processing circuit 34 in wireless communication device 12 having circuitry 60 that generates a composite audio signal for transmission to one or more remote parties 14, 16, 18. The composite audio signal includes components of the user's speech detected at microphone 50 supplemented with the audio signals derived from a selected audio file 70 stored in memory 68. The circuitry 60 might be beneficial, for example, in situations where users wish to hear background music during a conversation. By way of example, a user having a conversation with a spouse might select a romantic melody to be played as background music to romantically enhance the conversation. Angry or happy users may select other music that appropriately portrays their current emotional feeling to another party during a conversation. Another situation in which circuitry 60 could be beneficial is when one user wishes to share a selected song with another user during a conversation. In another scenario, a user may wish to add the sound of a baby crying to a voice conversation, and use that sound as a reason to terminate the conversation.

The circuitry 60 is communicatively connected to a transmit/receive chain 62 capable of transmitting and receiving digital cellular signals to and from one or more of the remote parties 14, 16, 18 via RAN 20. The transmit/receive chain 62 comprises a speech codec 64 to encode/decode signals transmitted to and received from the CS-CN 22 and/or the PS-CN 24. In some embodiments, the transmit/receive chain 62 may also comprise the receiver 40 and the transmitter 42.

For received signals, speech codec 64 decodes a digital signal output by the receiver 40 according to a connection-appropriate protocol. In one embodiment, the speech codec 64 decodes speech signals received from the circuit-switched network according to the AMR protocol, and packet data traffic received from the packet-switched network using the G.711 protocol. However, those skilled in the art will realize that other protocols may be used. The decoded speech signals, which are still in the digital domain, are then converted to analog signals using a digital-to-analog converter (DAC) 72. An amplifier 74 drives the speaker 50 to render the analog signals as audible sound for the user of the wireless communications device 12.

For transmitted signals, microphone 48 detects and converts the user's voice into analog signals. An analog-to-digital converter (ADC) 76 converts those signals into digital signals. The system controller 36 controls the speech codecs 64 to encode the user's speech according to a connection-appropriate protocol. Speech codec 64 then sends the encoded speech signals to the transmitter 42 for transmission to one or more of the remote parties 14, 16, 18 over the circuit-switched and/or packet-switched connections.

Circuitry 60 may also include an audio decoder 66 to decode an audio file 70 stored in memory 68 and a mixer circuit 78. The audio decoder 66 decodes the audio file 70 (e.g., a music file) responsive to control signals generated by controller 36 to generate supplemental audio signals. The audio file 70 may be stored in any known format such as the Motion Picture Experts Group Layer-3 (MP3) format or the WAVEform audio format Sound (WAV). Those skilled in the art will readily appreciate that these specified formats are illustrative only, and that other formats are possible.

According to one embodiment of the present invention, the controller 36 generates a control signal responsive to a user command to generate first and second composite audio signals. Responsive to the control signal, the audio decoder 66 decodes the audio file 70 and produces a supplemental audio signal. The mixer circuit 78 then generates a composite audio signal for transmission by mixing speech signals representing the user's voice with the supplemental audio signals. Circuitry 60 outputs the composite audio signal to the speech codec 64 for speech encoding and transmission to one or more remote parties 14, 16, 18 via established circuit-switched and/or packet-switched connections. Upon receipt, the remote parties 14, 16, 18 decode the composite audio signal to hear a composite audible sound comprising the user's speech and the supplemental audio signal.

The mixer circuit 78 may also mix decoded speech signals received from one or more of the remote parties 14, 16, 18 with the supplemental audio signal to generate a composite audio signal for rendering to the user. In one embodiment, the mixer circuit 78 outputs the composite audio signal to the DAC 72 and amplifier 74 for rendering to the user over speaker 50. The user therefore hears a second composite audible sound comprising of the speech of the one or more remote parties 14, 16, 18 and the supplemental audio signal.

The mixer circuit 78 may be bypassed when the audio decoder 66 does not produce the supplemental audio signal for mixing. Alternatively, speech signals may continue to pass through the mixer circuit 78 without being mixed with supplemental audio signals. This would allow the user and/or the one or more of the remote parties 14, 16, 18 to hear only each other's voices during the conversation as is conventional.

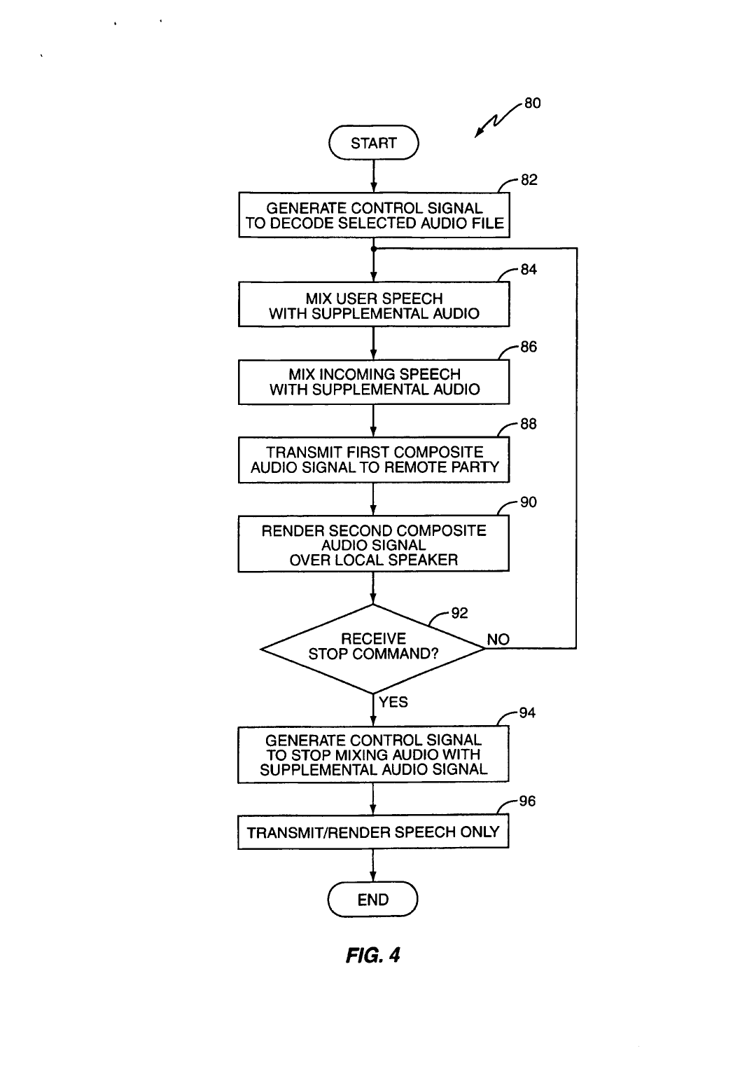

FIG. 4 is a flow diagram that illustrates a method 80 in which the circuitry 60 generates the first and second composite audio signals. It may be assumed for this method that the user and one or more of the remote parties 14, 16, 18 have established a circuit-switched and/or packet-switched connection.

The method begins when controller 36 generates a control signal to audio decoder 66 (box 82). Controller 36 may generate the control signal responsive to user input entered via UI 32, for example. Upon receipt of the control signal, the audio decoder 66 decodes a selected audio file 70 according to an appropriate format to generate the supplemental audio signal. The supplemental audio signal is output to the mixer circuit 78 where it is mixed with the user's speech signals to generate a first composite audio signal (box 84). The mixer circuit 78 also mixes the supplemental audio signal with incoming speech signals received from one or more of the remote parties 14, 16, 18 to generate a second composite audio signal (box 86). The mixer 78 then outputs the first composite audio signal to the speech codec 64 for the appropriate speech encoding and transmission to one or more of the remote parties 14, 16, 18 (box 88), and outputs the second composite audio signal for rendering to the user over the speaker 50 (box 90). The user and/or the remote party may adjust the volume of the supplemental audio signals relative to the volume of the speech using one or more controls on their respective UIs 32. Either party to the conversation could alter the volume with or without changing the volume for the other party.

Mixing the supplemental audio signals with the user's speech and the incoming decoded speech signals may continue until the controller 36 receives a user command to cease mixing the audio signals (box 92). Upon receipt of a stop command, the controller 36 generates another control signal to cease mixing the audio signals (box 94). The parties to the conversation will then only hear each other's speech (box 96).

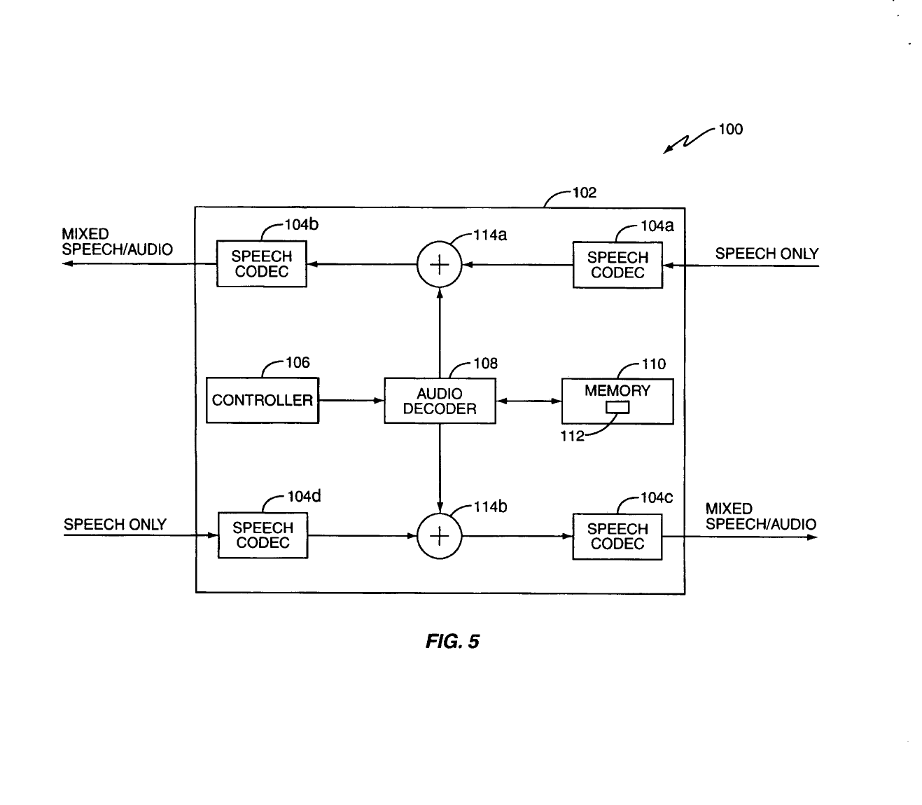

In another embodiment, the circuitry that generates the first and second composite audio signals resides in one or more components disposed in the wireless communication network. FIG. 5, for example, is a block diagram that illustrates an exemplary server 100 having circuitry 102 that generates the composite signals. The circuit 102 comprises one or more speech codecs 104a-d, a controller 106 connected to an audio decoder 108, memory 110 to store an audio file 112, and one or more mixing circuits 114a-b. Each of these components performs substantially the same function as those of FIG. 4.

Those skilled in the art will readily appreciate that the circuitry 102 may comprise one speech codec 104 or multiple speech codecs 104a-d as needed or desired. Likewise, the circuit 102 may comprise a single mixing circuit 114 or multiple mixing circuits 114a-b. In the embodiment of FIG. 5, these circuits are shown as being multiple blocks; however, this is for illustrative purposes and to facilitate ease of discussion only. There is no upper or lower limit on the number or types of speech codecs 104 or mixing circuits 114 that may be employed with the present invention.

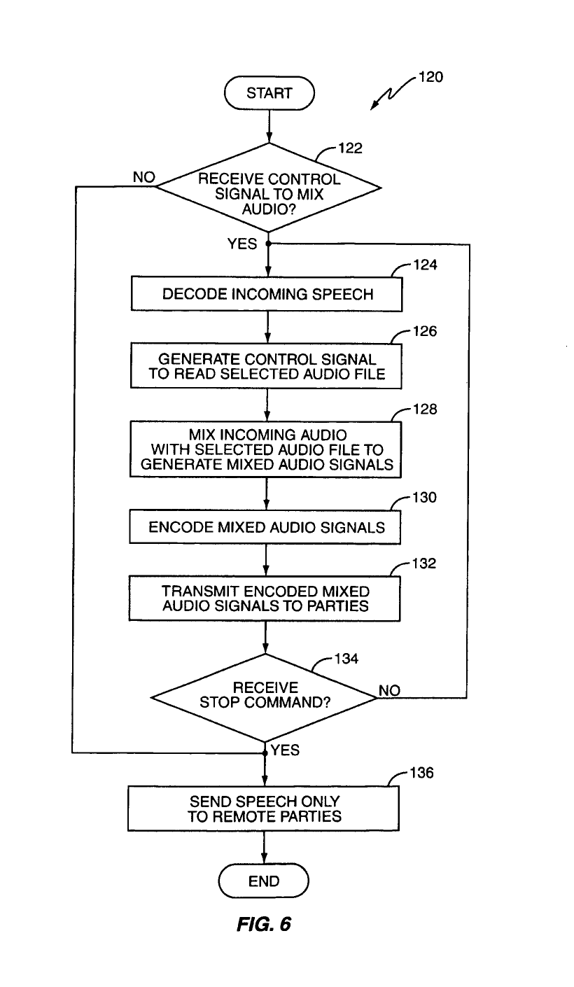

FIG. 6 is a flow diagram showing a method 120 in which the circuitry 102 in the network generates the first and second composite audio signals. As in the previous embodiment, method 120 assumes that the parties have already established a communications link.

The method begins when the controller 106 receives a user command to generate the composite audio signals (box 122). In one embodiment, for example, the command to generate the composite audio signals comprises one or more Dual Tone Multi Frequency (DTMF) tones entered by the user using a keypad on the user interface, although other methods may be used to generate the composite audio signals as described in more detail later. The speech codec 104a decodes the user's speech signals, while the speech codec 104d decodes the speech signals of the remote party (box 124). The audio decoder 108 reads and decodes a selected audio file 112 to generate the supplemental audio signal (box 126). The audio decoder 108 outputs the supplemental audio signal to the mixer circuits 114a, 114b where it is mixed with the decoded speech signals of the user and the remote party, respectively, to generate first and second composite audio signals (box 128). The speech codecs 104b, 104c then encode the first and second composite audio signals, respectively (box 130). The first composite audio signal is then transmitted to the remote party, and the second composite audio signal is transmitted to the user (box 132). As in the previous embodiment, the user and/or the remote party could raise and lower the volume of the supplemental audio signals relative to the volume of the speech using one or more controls on UI 32. Each party may increase and decrease the volume of the supplemental audio signals independently of the other party.

Generating and transmitting the first and second audio signals may continue until the controller 106 receives a stop command issued by the user (box 134). The stop command may be, for example, a second DTMF tone. Responsive to the stop command, controller 106 generates a control signal to the audio decoder 108 to cease outputting the supplemental audio signal to the mixer. Thereafter, the parties transmit and receive only the speech signals (box 136).

The previous embodiment describes using DTMF tones to command circuitry 102 to generate the composite audio signals, or to stop generating the composite audio signals. In another embodiment, however, the user may use Unstructured Supplementary Service Data (USSD) codes. USSD is a Global System for Mobile (GSM) communication technology used to send text between a mobile phone and an application program in the network, and is defined in the GSM standard documents GSM 02.90 and GSM 03.90, which are incorporated herein by reference in their entirety. The user may employ the UI 32 to enter one or more USSD codes during a conversation to command the circuitry 102 to generate and to stop generating the composite audio signals. The USSD codes, like the DTMF tones, may be input by the user without having to terminate or suspend an on-going call.

USSD is a call-session based technology, and thus, the network would know which call to apply the USSD code to. This information could be forwarded to the server 100 by the network. The USSD code might include, for example, alphanumeric data that specifies which music or audio file the user wishes to inject into the conversation. Upon receipt of the USSD code, the server 100 could access the selected file, and mix the audio signals from the selected file with the speech signals as previously described.

The controller 36 may be also configured to automatically generate the first and/or second composite audio signals responsive to a call control signal indicating an incoming or outgoing call. In these embodiments, the user may associate a particular audio file 70 with one or more names in an address book. Upon receiving a call, for example, controller 36 could generate the supplementary audio signals from the specified file. The supplementary audio signals could be used to greet the remote party before the user answers the call, and then mixed with the user's speech signals after the user answers the call.

As previously stated, the present invention enables the user of a cell phone or other communication device to enhance a voice conversation with supplemental audio rendered as background audio. The audio files may be in any known format, and may be downloaded to the communication device 10 from the network. Where the mixing circuitry resides in the network, the user may upload audio files to the network. Uploading and/or downloading the audio files may be accomplished using any method known in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of communicating a composite audio signal over a communication network, the method comprising:
receiving speech signals representing a user's voice;
generating a first composite audio signal comprising the user's speech signals and supplemental audio signals generated from a selected audio file;
speech encoding the first composite audio signal; and
transmitting the first composite audio signal to a remote party over a communication network.

2. The method of claim 1 wherein receiving speech signals representing a user's voice comprises receiving the speech signals from a microphone at the user's communication device.

3. The method of claim 2 wherein generating a first composite audio signal comprises:
decoding the selected audio file to generate the supplemental audio signal; and
mixing the supplemental audio signal with the user's speech signals to generate the first composite audio signal.

4. The method of claim 1 further comprising:
decoding speech signals received from the remote party at the communication device;
mixing the decoded speech signals with the supplemental audio signals to generate a second composite audio signal; and
rendering the second composite audio signal as a composite audible sound to the user.

5. The method of claim 1 wherein receiving speech signals representing a user's voice comprises receiving encoded speech signals at a server disposed in the communication network.

6. The method of claim 5 wherein generating a first composite audio signal comprises:
speech decoding the encoded speech signals at the server;
mixing the supplemental audio signal with the decoded speech signals to generate the first composite audio signal; and
speech encoding the first composite audio signal.

7. The method of claim 6 further comprising:
speech decoding speech signals received from the remote party;
mixing the supplemental audio signal with the decoded speech signals to generate a second composite audio signal;
speech encoding the second composite audio signal; and
transmitting the second composite audio signal to the user.

8. The method of claim 7 further comprising:
receiving the second composite audio signal at the user's communication device;
speech decoding the second composite audio signal; and
rendering the decoded second composite audio signal as a composite audible sound to the user.

9. The method of claim 1 further comprising mixing the speech signals from the user with the supplemental audio signals to generate the first composite audio signal responsive to receiving a first control signal.

10. The method of claim 9 wherein the first control signal comprises a call control signal indicating a two-way voice conversation between the user and the remote party.

11. The method of claim 9 wherein the first control signal is generated after a two-way voice conversation has been established between the user and the remote party.

12. The method of claim 9 further comprising ceasing to generate the first composite audio signal responsive to receiving a second control signal.

13. A communication device comprising:
a mixer circuit configured to generate a first composite audio signal comprising speech signals from a user of the communication device and supplemental audio signals from a selected audio file;
a speech codec configured to speech encode the first composite audio signal; and
a transceiver configured to transmit the first composite audio signal to the remote party over a communication network.

14. The communication device of claim 13 further comprising a microphone, and wherein the user's speech signals comprise speech signals generated at the microphone.

15. The communication device of claim 14 further comprising an audio decoder circuit configured to decode the selected audio file to produce the supplemental audio signals.

16. The communication device of claim 14 wherein the speech codec is further configured to decode speech signals received from the remote party.

17. The communication device of claim 16 wherein the mixer circuit is further configured to mix the decoded speech signals with the supplemental audio signals to generate a second composite audio signal.

18. The communication device of claim 17 further comprising a speaker to render the second composite audio signal as a composite audible sound to the user.

19. The communication device of claim 13 further comprising a controller configured to generate a first control signal to cause the mixer circuit to generate the first composite audio signal.

20. The communication device of claim 19 wherein the controller is further configured to generate a second control signal to cause the mixer circuit to cease generating the first composite audio signal.

21. The communication device of claim 13 wherein the communication device comprises a wireless communication device.

22. A server disposed in a communication network, the server comprising:
a first speech codec configured to speech decode an incoming signal from a user of a communication device to produce speech signals representing the user's voice;
a first mixer circuit configured to generate a first composite audio signal comprising the user's speech signals and supplemental audio signals generated from a selected audio file; and
the first speech codec further configured to speech encode the first composite audio signal for transmission to a remote party.

23. The server of claim 22 further comprising a second speech codec configured to decode an incoming signal from the remote party to produce speech signals representing the remote party's voice.

24. The server of claim 23 further comprising a second mixer circuit configured to generate a second composite audio signal comprising the remote party's speech signals and the supplemental audio signals.

25. The server of claim 24 wherein the second speech codec is further configured to speech encode the second composite audio signal for transmission to the user.

26. The server of claim 22 further comprising a controller configured to generate first and second control signals responsive to receiving input from the user.

27. The server of claim 26 wherein the first mixer circuit is configured to generate the first composite audio signal responsive to the first control signal, and to cease generating the first composite audio signal responsive to the second control signal.

28. The server of claim 22 further comprising an audio decoder to decode the selected audio file and produce the supplemental audio signal.
